(19) United States
(12) Patent Application Publication
(10) Pub. No.: US 2018/0243644 A1
(43) Pub. Date: Aug. 30, 2018

(54) Periodic Table Based Game System

(71) Applicant: Mihir Sai Konkapaka, San Diego, CA (US)

(72) Inventor: Mihir Sai Konkapaka, San Diego, CA (US)

(21) Appl. No.: 15/442,456

(22) Filed: Feb. 24, 2017

(51) Int. Cl. A63F 3/04; G09B 19/00

(52) U.S. Cl. CPC A63F 3/0457; A63F 2003/0476; G09B 19/00

(57) ABSTRACT

The present invention is a periodic table based game system. The game board has a periodic table of elements printed upon it. Each of the elements is covered by a magnetic piece with a matching atomic number, such that the players may only view the atomic number of the elements. The game begins when the first player chooses a stick or card with an element name and symbol on it. The player then must lift a magnetic piece to reveal the same element that is listed on the stick or card. If they are successful, they are rewarded points and the next player takes a turn. If they fail three times, the next player will also have three attempts to uncover the correct element and receive points. When all magnetic pieces are removed, the player with the highest sum of points wins the game.

### BACKGROUND OF THE INVENTION

### 1. Field of Invention

The present invention relates to the field of games, and more specifically to educational games.

### 2. Description of Related Art

Memorizing a large portion of information can be a daunting task for anyone to accomplish. For students undergoing or continuing their education, they are often required to memorize large amounts of information. Furthermore, they may have to memorize information from a diverse range of subjects.

Almost all students will end up taking a chemistry course at some point in their academic career. Part of almost every chemistry course includes having to memorize all, or at least part, of the periodic table of elements. Memorizing the periodic table of elements is not a simple task. There are 118 elements on the modern periodic table, and each element is provided with further information, such as element symbols, atomic numbers, atomic mass, electron configuration, group, and period. For some students memorization just does not come naturally, and that can be especially true with memorizing the periodic table.

When attempting to memorize any information, reading the information multiple times tends to fail most. Simply reading can be tiring and repetitive. Many students turn to memorization techniques to try and solidify the information in their minds. These memorization techniques might include flashcards, mind mapping, the story method, or the peg system. While these techniques may have some success, most students will find them to be boring. Consequently, if a student is bored by studying, then they will be less likely to study in the first place.

Based on the foregoing, there is a need in the art for an entertaining way to memorize the details of the periodic table of elements. What might be further desired is a game wherein a student will study the periodic table of elements as they play.

### SUMMARY OF THE INVENTION

The present invention is a periodic table based game system. In the preferred embodiment, the game system is provided with a board. The board is comprised of a ferromagnetic material and is provided with the full image of the periodic table of elements on its surface.

The games system is further provided with a plurality of magnetic pieces. In the preferred embodiment, the magnetic pieces have one side imaged with an atomic number. One magnetic piece will be provided per element. The magnets will be placed onto the corresponding element.

In the preferred embodiment, the game system is further provided with a plurality of sticks. Each stick will have an element name and element symbol marked upon one of its surfaces. The sticks which have yet to be drawn will be provided in a pick-up container, and the sticks which have already been drawn will be provided in a drop container.

In another embodiment, the plurality of sticks will be replaced with a plurality of cards. In the embodiment, the cards will have an element name and element symbol marked on one of its sides. In an embodiment, the cards will be further provided with a fact about the listed element.

In the preferred embodiment, after the magnetic pieces have been placed over the periodic table, the game begins when a first player draws a stick from the pick-up container. The first player then lifts a magnetic piece, to reveal an element from the periodic table. If the element on the table matches the element on the stick, the first player receives 5 points, the magnetic piece is removed from the periodic table, and the next player takes a turn.

In the preferred embodiment, if the element on the table does not match the element on the stick, the player returns the magnetic piece to the corresponding element on the periodic table, and is given two more attempts to reveal the correct element. If after three attempts, the player does not match the element on the stick to an element on the table, then the next player attempts to match the element, on the same stick, to the element on the table by lifting a corresponding magnetic piece.

In the preferred embodiment, if the player, who picked the stick, makes a correct match, they will receive 5 points for the match. If a player does not make a correct match in three attempts, the next player who correctly matches the stick will receive 10 points for the match.

In the preferred embodiment, the game continues until all of the magnetic pieces have been removed from the periodic table. After completion, all players will add up their points, and the player with the highest score is declared the winner.

In an alternate embodiment, a reduced point system may be used. In the embodiment, a player who picks a stick will receive 5 points for a match on the first attempt, 3 points for a match on the second attempt, and 1 point for a match on the third attempt. A player who inherits a stick (the player before failed three times), will receive 10 points for a match on the first attempt, 5 points for a match on the second attempt, and 3 points for a match on the third attempt.

In another embodiment, the game will be played in the same manner, however cards will replace the sticks.

The foregoing, and other features and advantages of the invention, will be apparent from the following, more particular description of the preferred embodiments of the invention, the accompanying drawings, and the claims.

### BRIEF DESCRIPTION OF THE DRAWINGS

For a more complete understanding of the present invention, the objects and advantages thereof, reference is now made to the ensuing descriptions taken in connection with the accompanying drawings briefly described as follows.

FIG. 1 is a perspective view of the periodic table based game system , according to an embodiment of the present invention;

### DETAILED DESCRIPTION OF PREFERRED EMBODIMENTS

Memorizing a large portion of information can be a daunting task for anyone to accomplish. For students undergoing or continuing their education, they are often required to memorize large amounts of information. Furthermore, they may have to memorize information from a diverse range of subjects.

Almost all students will end up taking a chemistry course at some point in their academic career. Part of almost every chemistry course includes having to memorize all, or at least part, of the periodic table of elements. Memorizing the periodic table of elements is not a simple task. There are 118 elements on the modern periodic table, and each element is provided with further information, such as element symbols, atomic numbers, atomic mass, electron configuration, group, and period. For some students memorization just does not come naturally, and that can be especially true with memorizing the periodic table.

When attempting to memorize any information, reading the information multiple times tends to fail most. Simply reading can be tiring and repetitive. Many students turn to memorization techniques to try and solidify the information in their minds. These memorization techniques might include flashcards, mind mapping, the story method, or the peg system. While these techniques may have some success, most students will find them to be boring. Consequently, if a student is bored by studying, then they will be less likely to study in the first place.

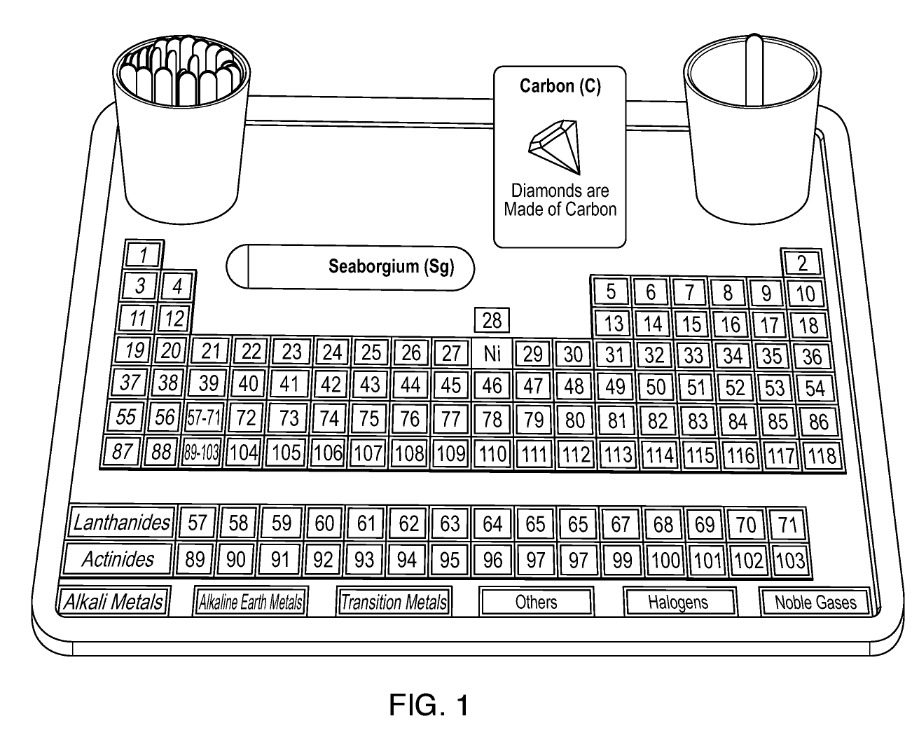

Preferred embodiments of the present invention and their advantages may be understood by referring to FIG. 1, wherein like reference numerals refer to like elements.

In reference to FIG. 1, a preferred embodiment of the present invention is shown, wherein a board 1 is provided with the periodic table of elements 5 imaged on to the surface of the board. The periodic table is imaged in the standard format, wherein the elements are arranged by their atomic number, electron configuration, and chemical properties. In the preferred embodiment, the board is comprised of a ferromagnetic component to retain magnets.

In the preferred embodiment, the elements and their corresponding information are then covered by magnetic game pieces 10. Each of the magnetic pieces is imaged with an atomic number on one of its surfaces. In the preferred embodiment, the magnetic pieces 10 are colored to correspond with the group in which the element belongs to. The magnetic game pieces are placed on top of the periodic table, such that the information for each element is hidden by the magnetic piece. This leaves only the atomic numbers to be visible to the players of the game.

To begin the game, one player picks a stick 15, at random, from the pick container 20. In the preferred embodiment, each stick 15 has the name of an element 16 and its chemical symbol 17 printed on at least one side of the stick 15. Furthermore, the stick 15 will have a pigment 18 at one of its ends to indicate the end which should be placed near the top of the container 20, such that the players are unable to see the element or symbol printed on the stick. After picking a stick, the player will attempt to remove the magnetic piece to reveal the corresponding element information under the magnetic piece.

If the revealed element matches the element on the stick, then the player is awarded 5 points for correctly matching. Furthermore, the magnetic piece is removed from play and the element information is left exposed. The picked stick is then placed into the drop container 25.

If the player does not uncover the correct element which corresponds with the element provided on the stick, the magnetic piece is placed back into its position on the board to recover the element which was incorrectly revealed. The player is then given two additional attempts (for a total of three attempts) to correctly find the corresponding element on the board for 5 points.

After three attempts, if the player does not successful uncover the correct element, then the next player is given three attempts to uncover the corresponding element. In a preferred embodiment, the order of players is decided before the game begins. If the next player successfully uncovers the element listed on the stick, then that player is awarded 10 points. The correct magnetic piece is then removed from the board, and the stick is placed into the drop container.

If the player is unsuccessful after three attempts, then the next player or original player (if only two people are playing) is given the chance to uncover the appropriate element to receive 10 points. The game is played in this manner until all magnetic pieces are removed from the board, and the entire periodic table is uncovered.

In an embodiment, a reduced point system may be used, wherein each failed attempt to uncover the correct element results in a reduction of points received by the player when they finally uncover the correct element. For example, if the player uncovers the correct element on the first attempt they will receive the full 5 points. If they uncover the correct element on the second attempt they will receive a reduced 3 points, and if they uncover the correct element on the third attempt they will receive only 1 point. It can be appreciated that the point values may be change, the above values are provided only for the purpose of illustration.

In another embodiment, the points that a player can receive will vary. However, a player should receive a high amount of points on their first correct attempt, an intermediate amount of points on a second correct attempt, and a lower amount of points on a third correct attempt. As an example, the high point, intermediate and lower amount of points could be 10, 5, 3 respectively. The points could change as the players can place a higher emphasis on getting the correct attempt on the first attempt. For example, in a game played amongst three skilled players, the first correct attempt could be a high score of 20 points, the second correct attempt could yield an intermediate amount of 5 points, and the third correct attempt would yield a lower amount such as one point. These examples are not meant to limit the point threshold. However, in preferred embodiments, there would be a three-tiered point structure which correlates to the number of correct guesses.

After game play is complete, each player's points are added up, and the player with the highest number of points is declared the winner.

In another embodiment of the invention, the sticks 15 are replaced with cards 30. In the embodiment, the cards 30 will have an element name and symbol, along with a fact about the element. In another embodiment, the card may provide an element's atomic number, atomic mass, electron configuration, or other known information about the element. In the embodiment, the players will have to match the card to an element using the information provided on the card.

The invention has been described herein using specific embodiments for the purposes of illustration only. It will be readily apparent to one of ordinary skill in the art, however, that the principles of the invention can be embodied in other ways. Therefore, the invention should not be regarded as being limited in scope to the specific embodiments disclosed herein, but instead as being fully commensurate in scope with the following claims.

I claim:

1. A periodic table based game system comprising:
a game board;
a periodic table of elements imaged onto the board;
a plurality of game pieces, each game piece having an atomic number imaged on at least one side of said game piece;
a plurality of sticks, each stick having a first end and a second end, wherein an element and an element symbol are imaged on the first end;
a first container to receive the plurality of sticks and having an opening and a bottom;
a second container to receive the plurality of sticks;
wherein the plurality of game pieces is placed onto the periodic table of elements, and wherein the plurality of game pieces is able to be removed by a user to uncover the periodic table of elements imaged onto the board.

2. The periodic table based game system of claim 1, wherein the game board is ferromagnetic and the plurality of game pieces is magnetic.

3. The periodic table based game system of claim 1, wherein the plurality of sticks is received by the first container such that the first end of each stick is disposed at the bottom of the first container.

4. A periodic table based game system comprising:
a board;
a periodic table of elements imaged onto the board;
a plurality of game pieces, each game piece having an atomic number imaged on one side of said game piece; and
a plurality of cards, each card having a face and a back, wherein an element name and an element symbol is imaged onto the face of each card;
wherein the plurality of game pieces is placed onto the periodic table of elements, and wherein the plurality of game pieces is able to be removed by a user to uncover the periodic table of elements.

5. A method of playing using a periodic table based game system having:
a board comprised of a ferromagnetic material;
a periodic table of elements imaged onto the board;
a plurality magnetic pieces, each magnetic piece having an atomic number imaged on one side of the magnetic piece;
a first container;
a second container; and
a plurality of sticks, each stick having an element and an element symbol imaged on at least one side of the stick;
wherein the method of playing the periodic table based game has steps comprising:
i. one or more players placing the plurality of magnetic pieces on top of the periodic table to cover the periodic table of elements;
ii. a first player choosing a stick from the plurality of sticks provided in the first container;
iii. the first player matching the element and the element symbol imaged on the stick with a matching element provided on the periodic table of elements;
iv. the first player receiving points for a correct match;
v. placing the stick into the second container; and
vi. a next player choosing a stick form the plurality of sticks, wherein the method of playing the periodic table based game system is repeated until all of magnetic pieces of the plurality of magnetic pieces are removed from the periodic table of elements.

6. The method of playing the periodic table based game system of claim 5, further comprising a step wherein the one or more players are given three attempts to find the correct match.

7. The method of playing the periodic table based game system of claim 6, further comprising a step wherein if the one or more players does not correctly find the correct match after three attempts, the next player is given an opportunity to find the correct match.

8. The method of playing the periodic table based game system of claim 6, wherein the player receives a an intermediate amount points if they find the correct match on a second attempt.

9. The method of playing the periodic table based game system of claim 6, wherein the player receives a lower amount of points if they find the correct match on a third attempt.

10. The method of playing the periodic table based game system of claim 7, wherein the next player is given three attempts to find the correct match.

11. The method of playing the periodic table based game system of claim 10, wherein the next player receives a high amount of points if they find the correct match on a first attempt.

12. The method of playing the periodic table based game system of claim 10, wherein the next player receives an intermediate amount of points if they find the correct match on a second attempt.

13. The method of playing the periodic table based game system of claim 10, wherein the next player receives a lower amount points if they find the correct match on a third attempt.
